(19) United States
(12) Patent Application Publication
(10) Pub. No.: US 2020/0119553 A1
(43) Pub. Date: Apr. 16, 2020

(54) POWER MANAGEMENT SYSTEM FOR STANDBY GENERATOR

(71) Applicant: BRIGGS & STRATTON CORPORATION, Wauwatosa, WI (US)

(72) Inventors: David PROCHNIAK, Dousman, WI (US); Michael MILLER, Lake Mills, WI (US); Timothy Scott OGDEN, Oconomowoc, WI (US)

(73) Assignee: BRIGGS & STRATTON CORPORATION, Wauwatosa, WI (US)

(21) Appl. No.: 16/600,185

(22) Filed: Oct. 11, 2019

Related U.S. Application Data
(60) Provisional application No. 62/744,738, filed on Oct. 12, 2018.

(51) Int. Cl. H02J 3/14; H02J 3/00; G06F 1/26

(52) U.S. Cl. CPC H02J 3/14; H02J 9/08; G06F 1/26; H02J 3/005

(57) ABSTRACT

A power management system for use with a generator includes a generator selectively supplying power to one or more load sources, the generator including an engine. The system also includes a controller communicably and operatively coupled to the generator to control operation of the generator and a user device including a user interface and configured to receive user input on the user interface and transmit the user input to the controller. The controller includes a priority circuit structured to receive the user input from the user device and control the generator to selectively supply power to a subset of the one or more load sources based on the user input.

### CROSS-REFERENCE TO RELATED APPLICATIONS

This application claims the benefit of and priority to U.S. Provisional Patent Application No. 62/744,738, filed Oct. 12, 2018, the entire contents of which are incorporated herein by reference.

### BACKGROUND

The present invention generally relates to internal combustion engines and generators powered by such engines. More specifically, the present invention relates to a control system for a generator.

### SUMMARY

One embodiment of the disclosure is a power management system for use with a generator including a generator selectively supplying power to one or more load sources, the generator including an engine. The power management system includes a controller communicably and operatively coupled to the generator to control operation of the generator. The power management system also includes a user device including a user interface and configured to receive user input on the user interface and transmit the user input to the controller. The controller includes a priority circuit structured to receive the user input from the user device and control the generator to selectively supply power to a subset of the one or more load sources based on the user input.

Another embodiment of the disclosure is a generator for supplying power to one or more load sources, the generator including an engine, an alternator configured to be driven by the engine to produce electricity, a throttle movable to multiple positions between closed and wide-open, a governor coupled to the throttle to open and close the throttle, and a controller. The controller is configured to control operation of the generator and includes a priority circuit structured to receive user input from a user device and control the generator to selectively supply power to a subset of the one or more load sources based on the user input.

Another embodiment of the disclosure is a power management system for use with a generator, the system including a generator selectively supplying power to one or more load sources, the generator including an engine, a controller communicably and operatively coupled to the generator to control operation of the generator, and a user device including a user interface and configured to receive user input on the user interface and transmit the user input to the controller. The controller and the one or more load sources are communicably coupled via a ZigBee protocol device.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a schematic diagram of a generator according to an exemplary embodiment of the invention;

FIG. 2 is a schematic diagram of a power management system for use with the generator of FIG. 1, according to an exemplary embodiment of the invention;

FIG. 3 is a schematic diagram of the controller of FIG. 2, according to an exemplary embodiment of the invention;

FIG. 4 is a connectivity environment of the power management system of FIG. 2, according to an exemplary embodiment of the invention;

FIG. 5 is an example user interface of a user device for use with the power management system of FIG. 2;

FIG. 6 is another example user interface of a user device for use with the power management system of FIG. 2;

FIG. 7 is another example user interface of a user device for use with the power management system of FIG. 2; and

FIG. 8 is another example user interface of a user device for use with the power management system of FIG. 2.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, a power management system is shown. The power management system is configured to use real-time user input to selectively provide power to various load sources using a generator (e.g., standby generator powering a residence). The generator may be powering various load sources, including appliances, such as a refrigerator or oven, an air conditioner system, a furnace, lighting, etc. The power management system controls the generator to selectively power each of the load sources electrically connected to the generator. By receiving a user input, the system can selectively provide power to a subset of the load sources (e.g., that may be prioritized through user input). For example, a user may indicate (e.g., through an application on their mobile device) that power to an oven and dryer is not necessary during a power outage. As such, the power management system will not provide power to those load sources and instead, will prioritize other load sources electrically connected to the generator. Accordingly, the system described herein allows for the control of power supplied by generators through real-time user input.

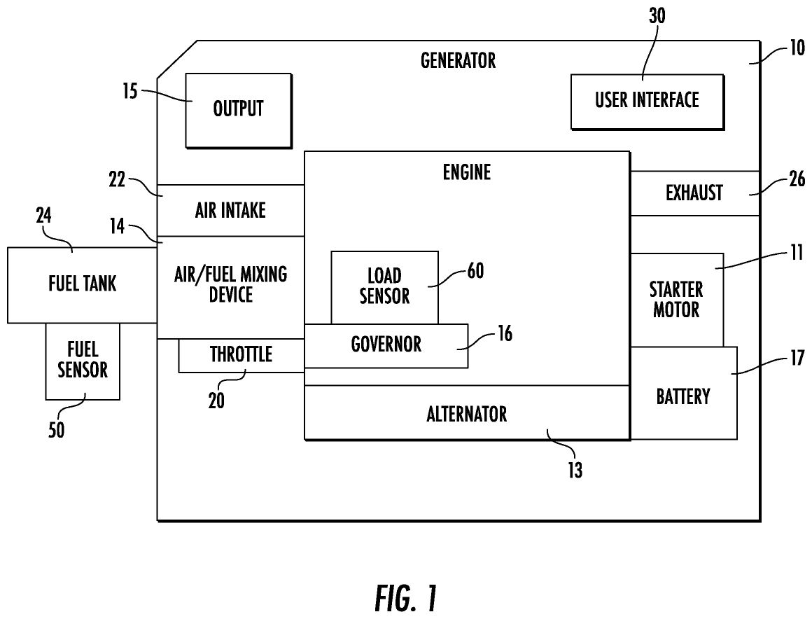

Referring to FIG. 1, a generator is shown according to an exemplary embodiment. The generator 10 includes an engine 12, including a starter motor 11, air/fuel mixing device 14, governor 16, throttle 20, air intake 22, exhaust outlet 26, and an alternator 13 driven by the engine 12. The starter motor 11 rotates a crankshaft to start the engine 12. The alternator 13 produces electrical power from input mechanical power from the engine 12. The alternator 13 charges a battery 17, which stores energy for use by the electrical systems of the generator. The generator 10 additionally includes one or more outputs 15 for supply of the generated electrical power to an electrical device of a user's choosing. The generator 10 shown in FIG. 1 also includes a fuel tank 24 for providing fuel to the air/fuel mixing device 14. The fuel tank 24 can include a liquefied petroleum gas (LPG) tank (e.g., propane tank) used to supply fuel to the generator 10. In some embodiments, the generator 10 is otherwise connected to a supply of natural gas. In some embodiments, the generator 10 includes a diesel fuel tank. In some embodiments, a fuel level sensor 50 is coupled to (e.g., within) the fuel tank 24 to sense an amount of fuel within the fuel tank 24.

In embodiments that include a fuel level sensor 50, the fuel level sensor 50 is configured to sense a fuel level within the fuel tank 24. In some embodiments, more than one fuel tank 24 may be used and as such, the fuel level sensor 50 can sense the fuel level in each tank (e.g., LPG tank, diesel tank). In one embodiment, a fuel level sensor 50 can be positioned within each fuel tank 24 such that the fuel level of each tank is determined. In another embodiment, a weight sensor can be positioned within each LPG tank such that the fuel levels of each LPG fuel tank can be determined.

Air flows into the engine 12 from the air intake 22 and through the air/fuel mixing device 14. As air passes through the air/fuel mixing device 14, the air mixes with fuel entering the air/fuel mixing device 14 from the fuel tank 24 and creates an air/fuel mixture that then enters the engine 12. The throttle 20 controls the flow of the air/fuel mixture that exits the air/fuel mixing device 14. The governor 16 controls the position of the throttle 20 based on a detected load on the engine 12. In one embodiment, the governor 16 is an electronic governor. In another embodiment, the governor 16 is a mechanical governor. The air/fuel mixture leaving the air/fuel mixing device 14 is combusted in one or more cylinders of the engine 12 and exhaust gas from combustion leaves the engine 12 through the exhaust outlet 26. In one embodiment, the air/fuel mixing device 14 includes an electronic fuel injection (EFI) system. In another embodiment, the air/fuel mixing device 14 includes a carburetor.

The throttle 20 is structured to control the flow of air/fuel mixture out of the air/fuel mixing device 14. The position of the throttle 20 is controlled by the governor 16 through a linkage which moves the throttle plate. Based on the load sensed by the governor 16, the throttle plate may be in a relatively more closed or relatively more open position. In some embodiments, a load sensor 60 may be coupled to the governor 16 to sense a load on the engine 12.

The load sensor 60 is configured to sense a load on the engine 12. As such, in some embodiments, the load sensor 60 is communicably coupled to the governor 16 to determine a load on the engine 12. In some embodiments, the load sensor 60 is communicably coupled to a throttle position sensor to determine a load on the engine 12. In another embodiment, the load sensor 60 is coupled to a manifold absolute pressure (MAP) sensor to detect the load on the engine 12. The MAP sensor responds to an intake manifold pressure and provides a sensed load reading based on that pressure. In yet another embodiment, the load sensor 60 includes a sensor at one or more outlets 15 to determine an output current for the generator 10 from which a load can be determined.

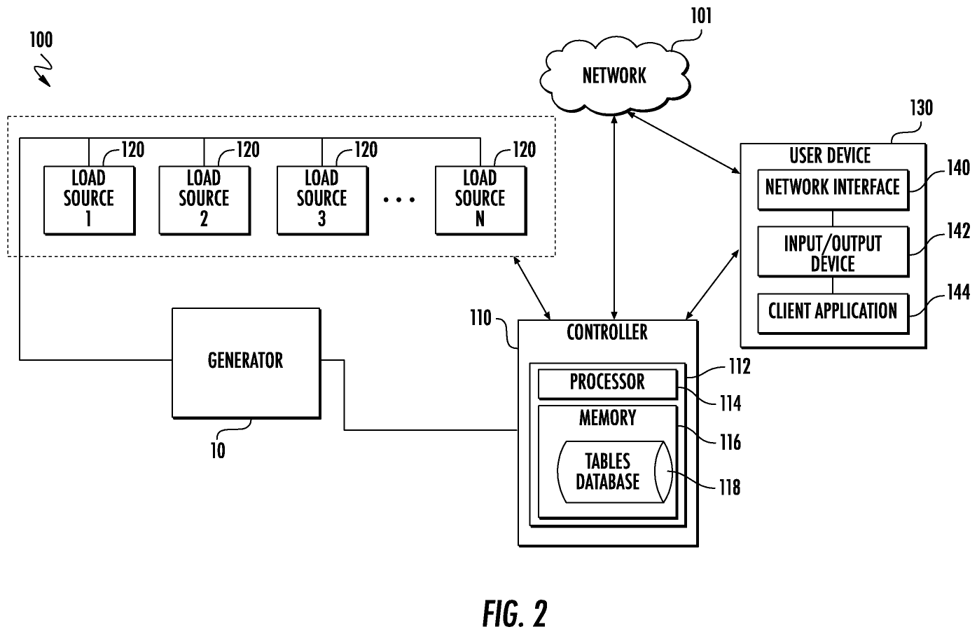

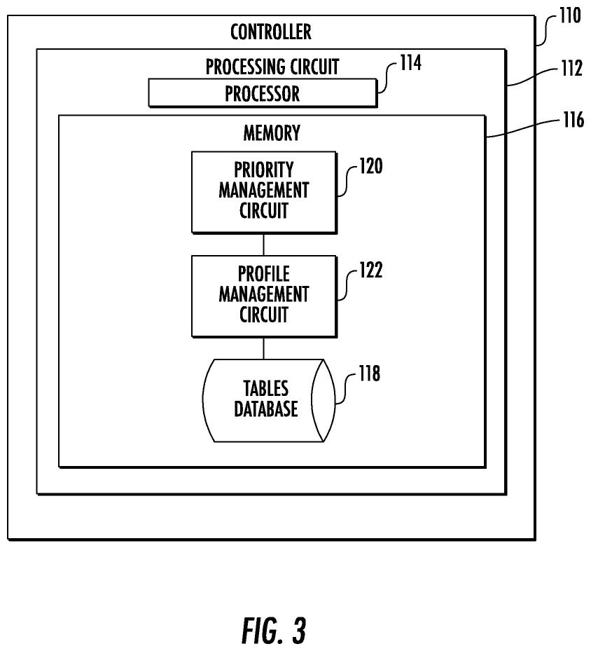

Referring to FIG. 2, a power management system 100 is illustrated, according to an exemplary embodiment. The power management system 100 can be used in a residential setting, where a standby generator (e.g., generator 10) is supplying power, for example, in situations where utility power may be down. The power management system 100 includes a controller 110, the generator 10, one or more load sources 120 powered by the generator 10, and a user device 130. The load sources 120 include any source of load on the generator 10 and can include, but are not limited to, a dryer, an oven, an air conditioning unit, a refrigerator, a furnace, a lighting system inside or outside a residence etc. The generator 10, the load sources 120, and the user device 130 are communicably and operatively coupled to the controller 110. The generator 10 is coupled to the load sources 120 via a transfer switch and internal wiring within the residence with which the generator 10 is being used. In some embodiments, the generator 10 is hardwired (e.g., connected) to the controller 110 via a shielded cable. In some embodiments, the generator 10 and the controller 110 are wirelessly connected. In some embodiments, the controller 110 is connected to the load sources 120 through a ZigBee protocol (e.g., ZigBee protocol device). In some embodiments, the controller 110 is a separate module coupled to the generator 10 (as shown in FIG. 2) and in some embodiments, the controller 110 is a module that is integrated with the generator 10 (as shown in FIG. 3). The user device 130 may be communicably and operatively coupled to the generator 10, controller 110, and one or more load sources 120 over a network 101, which may include one or more of the Internet, cellular network, Wi-Fi, ZigBee, or any other type of wired or wireless network.

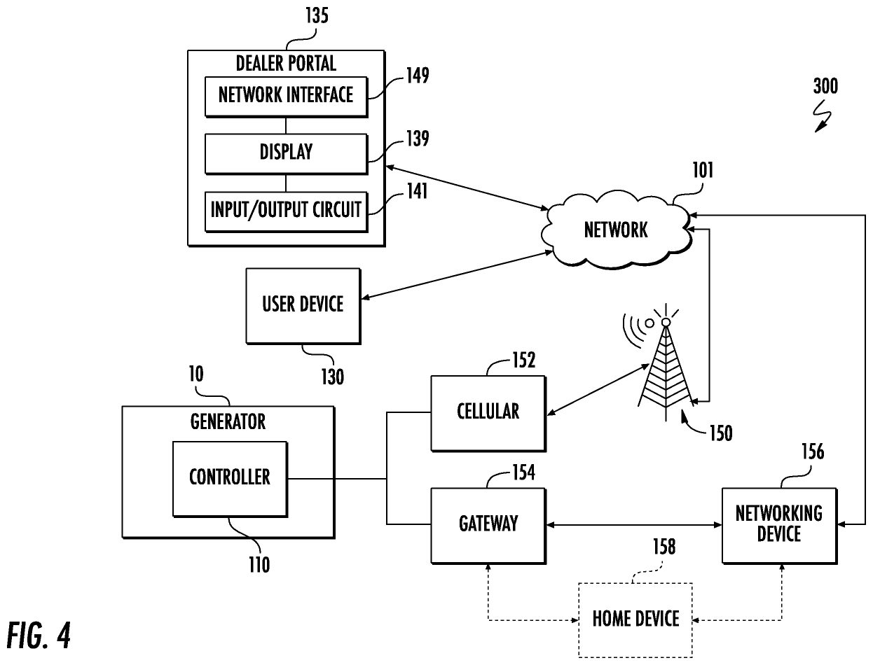

The user device 130 includes any type of computing device that may be used to control the operation of the power management system 100. In some embodiments, a user uses the user device 130 to communicate information to the controller 110 over the network 101. The user device 130 can also be used to control the operation of load sources 120 that are smart appliances (e.g., smart refrigerator, etc.) or smart lighting systems. The user device 130 can include any type of mobile device including, but not limited to, a phone (e.g., smart phone, etc.), tablet, personal digital assistant, and/or computing devices (e.g., desktop computer, laptop computer, personal digital assistant, etc.). The user device 130 can also include any wearable or non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. The user device 130 can also include any type of smart home device including a speaker and microphone to receive inputs from a user and notify the user of the status of the generator 10 and system 100. In some embodiments, as shown in FIG. 4, a separate home device 158 can be included with the system 100.

The user device 130 includes a network interface 140 enabling the user device 130 to exchange information over the network 101, an input/output (“I/O”) device 142, and a client application 144. The I/O device 142 is configured to exchange information with the user. An input device or component of the I/O device 142 allows the user to provide information to the user device 130, and may include, for example, a mechanical keyboard, a touchscreen, a microphone, a camera, a fingerprint scanner, any user input device engageable with the user device 130 via a USB, serial cable, Ethernet cable, and so on. An output device or component of the I/O device 142 allows the user to receive information from the user device 130, and may include, for example, a digital display, a speaker, illuminating icons, LEDs, and so on.

The client application 144 is structured to provide displays to the user device 130 that enable the user to manage the power management system 100. Accordingly, the client application 144 is communicably coupled to the generator 10 and controller 110. In some embodiments, the client application 144 may be incorporated with an existing application in use by a provider of smart home systems or smart appliance systems. In other embodiments, the client application 144 is a separate software application implemented on the user device 130. The client application 144 may be downloaded by the user device 130 prior to its usage, hard coded into the memory of the user device 130, or be a web-based interface application such that the user device 130 may provide a web browser to the application, which may be executed remotely from the user device 130. In the latter instance, the user may have to log onto or access the web-based interface before usage of the applications. Further, and in this regard, the client application 144 may be supported by a separate computing system including one or more servers, processors, network interface circuits, etc. that transmit applications for use to the user device 130. In certain embodiments, the client application 144 includes an API and/or a software development kit (SDK) that facilitate the integration of other applications with the client application 144. For example, the client application 144 may include an API that facilitates the receipt of information from a dealer portal (e.g., dealer portal 135 shown in FIG. 4).

Referring now to FIG. 4, in some embodiments, the user device 130 is in communication with the dealer portal 135 (e.g., over network 101). Accordingly, the dealer portal 135 can transmit various information to the user device 130 for display to the user (e.g., via client application 144). The dealer portal 135 can transmit weather alerts, maintenance information, scheduled servicing, etc. to the user device 130 for display.

The dealer portal 135 can include any type of computing device that may be used to facilitate management of the power management system 100. The dealer portal 135 may include any wearable and non-wearable device. Wearable devices refer to any type of device that an individual wears including, but not limited to, a watch (e.g., smart watch), glasses (e.g., eye glasses, sunglasses, smart glasses, etc.), bracelet (e.g., smart bracelet), etc. The dealer portal 135 may also include any type of mobile device including, but not limited to, a phone (e.g., smart phone, etc.) and/or computing devices (e.g., desktop computer, laptop computer, personal digital assistant, etc.).

The dealer portal 135 includes a network interface 137, which is used to establish connections with other components of the environment 400 by way of network 104. The network interface 137 includes program logic that facilitates connection of the dealer portal 135 to the network 101. The network interface 137 supports communication between the dealer portal 135 and other systems, such as the user device 130. For example, the network interface 137 includes a cellular modem, a Bluetooth transceiver, a Bluetooth beacon, an RFID transceiver, and an NFC transmitter. In some embodiments, the network interface 137 includes the hardware and machine-readable media sufficient to support communication over multiple channels of data communication.

The dealer portal 135 further includes a display 139 and an input/output circuit 141. The display 139 is used to present operational data, location information, alert information, warranty information, and the like on the dealer portal 135. In this regard, the display 139 is communicably and operatively coupled to the input/output circuit 141 to provide a user interface for receiving and displaying information on the dealer portal 135. The dealer portal 135 may display various information, such as, but not limited to, customer mapping, equipment status monitoring, service schedule and routing, historical routing, routing directions, weather notifications, map and grid-based equipment status, recent alert view and confirmations, equipment and crew alerts, various notifications regarding the generator 10 and/or power management system 100, geo-fencing of various sites (e.g., where various generators 10 are located across multiple residences), warranty information, service history, maintenance schedules, crew or technician tracking information, etc.

The input/output circuit 141 is structured to receive and provide communication(s) to a user of the dealer portal 135. In this regard, the input/output circuit 141 is structured to exchange data, communications, instructions, etc. with an input/output component of the dealer portal 135. Accordingly, in one embodiment, the input/output circuit 141 includes an input/output device such as a display device, a touchscreen, a keyboard, and a microphone. In another embodiment, the input/output circuit 141 may include communication circuitry for facilitating the exchange of data, values, messages, and the like between an input/output device and the components of the dealer portal 135. In yet another embodiment, the input/output circuit 141 may include machine-readable media for facilitating the exchange of information between the input/output device and the components of the dealer portal 135. In still another embodiment, the input/output circuit 141 may include any combination of hardware components (e.g., a touchscreen), communication circuitry, and machine-readable media.

Referring back to FIG. 2, the power management system 100 includes a controller 110. The controller 110 is configured to control operation of the generator 10 and to which load sources 120 the generator 10 is supplying power. As such, the controller 110 is communicably and operatively coupled to the generator 10 to control operation of the generator 10 and selectively couple and decouple (e.g., turn on and off) load sources 120 from the generator 10. The controller 110 communicates with the network 101 via a WiFi or Ethernet connection and the user's modem and router (e.g., networking device 156). The controller 110 communicates with the user device 130 via a WiFi connection.

As shown, the controller 110 includes a processing circuit 112, which may include a processor 114 and a memory 116. The processor 114 may be implemented as a general-purpose processor, an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 116 (e.g., RAM, NVRAM, ROM, Flash Memory, hard disk storage) may store data and/or computer code for facilitating the various processes described herein. Moreover, the one or more memory devices 116 may be or include tangible, non-transient volatile memory or non-volatile memory. Accordingly, the one or more memory devices 116 may include database components, object code components, script components, or any other type of information structure for supporting the various activities and information structures described herein.

The controller 110 further includes a tables database 118. The tables database 118 holds, stores, categorizes, and otherwise serves as a repository for load versus runtime look-up tables corresponding to a remaining runtime of the generator 10 based on a current sensed load and remaining fuel level. The tables database 118 stores values including, but not limited to, load, fuel level, and user inputs (e.g., priority information, profile settings, etc.), that may be used to determine a load source priority, remaining runtime of the generator 10, etc. The tables database 118 is structured to provide access to information relating to the sensed values of the engine 12 and generator 10. In this regard, the tables database 118 is communicably and operatively coupled to the other components of the controller 110 to provide access to such information, such that the controller 110 may perform a certain operation (e.g., turn on/off load sources 120) based on those values.

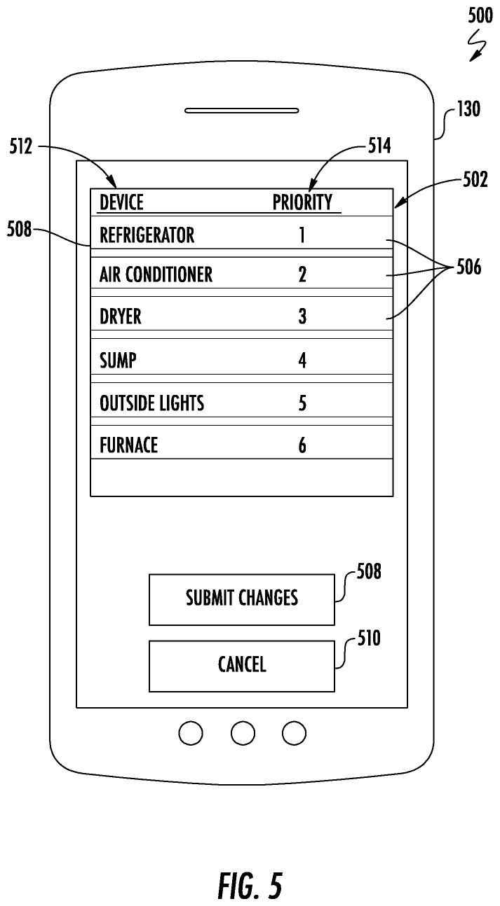

Referring now to FIG. 3, a diagram of a controller 110 is shown according to an exemplary embodiment. The controller 110 is configured to receive a user input provided by a user device 130 connected via a network 101 as shown in FIG. 2. User input may include, but is not limited to, a prioritization selection of load sources 120 (e.g., prioritizing dryer over oven, etc.), a profile selection (e.g., “Summer” profile, “Winter” profile, “Host” profile, etc.), an expected utility downtime, an amount of time to extend the generator runtime (e.g., extending runtime by hours and minutes), a preset generator shutdown time indicating to what time the user would like the generator runtime extended (e.g., extending the generator runtime to 10:30 pm). Various example user interfaces of the user device 130 are described in FIGS. 5-8. The controller 110 is shown to include a priority management circuit 220 and a profile management circuit 222 communicably coupled with each other. Other embodiments may include more or less circuits without departing from the spirit and scope of the present disclosure.

The priority management circuit 220 is configured to receive priority selection data as a user input from the user device 130 and use the priority data to turn load sources 120 on and off based on that priority preference. The user can prioritize all or some of the load sources 120 using the client application 144 on the user device 130. The prioritized list is transmitted from the user device 130 to the priority management circuit 220. The priority management circuit 220 communicates with the generator 10 and/or via gateway 154 (e.g., ZigBee device) to turn the load sources 120 on and off based on the received priority or profile settings information.

In some embodiments, the priority management circuit 220 is structured to determine a priority of load sources 120 that, when selectively powered, maximizes the runtime for the generator 10. The priority determination may or may not take into account received user prioritization input. For example, a user may indicate that a certain load source (e.g., a dryer, etc.) does not need to be powered during outages. In this case, the priority management circuit 220 will not prioritize that load source 120.

The profile management circuit 222 is structured to receive profile selection data as a user input from the user device 130 and use the priority data to selectively turn load sensors 120 on and off based on the profile setting. The user can create profile settings as desired and can select which of the load sources 120 should be on (or which load sources 120 should be off) while certain profile settings are selected. For example, the user can create a “Winter” profile setting and designate various load sources 120 to be on and off during the time period that the “Winter” profile setting is selected. To illustrate, the user may have designated that in the “Winter” profile setting, the furnace is to be prioritized above all other load sources 120 and the air conditioner should always be off. As another example, the user may create a “Host” profile setting, which may be selected during times when the user is hosting a party or a group of people are expected to be at the residence. The “Host” profile setting may be set by the user to always prioritize load sources 120, such as the oven and refrigerator, with other load sources 120, such as the dryer, set at a lower priority level. Various other profile settings may be established by the user using the client application 144 of the user device 130.

In some embodiments, the controller 110 further includes a fuel level sensing circuit and a load sensing circuit, each structured to receive values from the corresponding sensors. The load sensing circuit is structured to receive a sensed load value of the engine from the load sensor 60 and the fuel level sensing circuit is structured to receive a fuel level value from the fuel sensor 50. In some embodiments, these values may be used to determine a remaining runtime of the generator 10. For each sensed load on the engine 12, the runtime varies, as more or less fuel is consumed based on the load on the engine 12. With the same amount of fuel left in the fuel tank 24, the remaining generator runtime is longer for lower loads on the engine 12 than for higher loads on the engine 12 due to more fuel being consumed under higher loads. In some embodiments, the controller 110 communicates the determined runtime data to the user interface 30 of the generator 10 and/or the user device 130. In some embodiments, the controller 110 can also determine the runtime in various operating scenarios and generate a message displaying various scenarios to the user. The scenarios can include an expected generator runtime based on if certain load sources 120 are switched off and suggestions to switch off particular load sources 120 to achieve a certain generator runtime goal. These scenarios can be transmitted to and displayed on the user device 130 in the form of user interfaces.

In addition, in some embodiments, the controller 110 further includes a battery sensing circuit configured to receive battery voltage and status information from the generator 10 regarding battery 17. In some embodiments, the controller 110 further receives engine 12 operational or run status information from the generator 10. In some embodiments, the controller 110 further receives fault conditions or statuses from the generator 10 indicative of a fault condition.

Referring to FIG. 4, a connectivity environment 300 is shown, according to an exemplary embodiment. In the connectivity environment 100, data communication between the generator 10, the user device 130, and in some embodiments, a dealer portal 135, in various combinations is facilitated by the network 101. In some embodiments, the network 101 includes cellular transceivers. In another arrangement, the network 101 includes the Internet. In yet another arrangement, the network 101 includes a local area network or a wide area network. The network 101 may be facilitated by short and/or long range communication technologies including ZigBee devices, Bluetooth transceivers, Bluetooth beacons, RFID transceivers, NFC transceivers, Wi-Fi transceivers, cellular transceivers, wired network connections, etc.

As shown in FIG. 4, the connectivity environment 300 facilitates data communication between the controller 110 of the generator 10 and the network 101 using two-way cellular communication 152, with a cellular tower 150, and a gateway 154 (e.g., using a ZigBee device) connected to the network 101 via a networking device 156 (e.g., home router, etc.). In one embodiment, the connectivity environment 300 is facilitated by a cloud-based system via Wi-Fi only. In another embodiment, the user device 130, the controller 110, and the load sources 120 are communicably and operatively coupled via a ZigBee device. In another embodiment, the connectivity environment 300 is facilitated by a cloud-based system via cellular transceivers. In another embodiment, the connectivity environment 300 is facilitated by two-way cellular communication 152 using a cellular tower 150 and a Wi-Fi network (e.g., established by networking device 156) through a gateway 154. In yet another embodiment, the connectivity environment 300 is facilitated by a cloud-based system via ZigBee and cellular transceivers. In all such embodiments, the cloud-based system can be made accessible to a third party, such as a consumer (e.g., user device 130) and dealer (e.g., dealer portal 135). In some embodiments, the controller 110 communicates with the user device 130 via WiFi. In some embodiments, the controller 110 is communicably and operatively coupled to the load sources 120 (shown in FIG. 2) via a ZigBee protocol device (e.g., device implementing the ZigBee protocol). In some embodiments, if the system 100 is outside the WiFi network, remote monitoring and control of the power management system 100 is routed through the controller 110 to the network 101 and back to the controller 110 to control the system 100.

In some embodiments, the environment 300 includes a home device 158. The home device 158 includes any device configured to perform tasks for a user in response to a voice command. Accordingly, in some embodiments, the user voice assistant 102 is a specific device configured specifically to be a voice assistant (e.g., an Echo® device sold by Amazon® running the Alexa® digital assistant, a Google Home® device, etc.). In other embodiments, the home device 158 is a user device configured for other purposes but also capable of acting as a voice assistant (e.g., user device 130 can act as the home device 158). In some embodiments, the home device 158 is integrated directly into the construction of homes or apartments (e.g., through computing elements, speakers, microphones, etc. distributed throughout a home, including in all homes/residences in a development project, apartment complex, subdivision, etc.). The home device 158 is configured to receive voice data from a user relating to a operation of the generator 10 and/or operation of the load sources 120 including, but not limited to, priority selection data, profile generation data, profile selection data, individual load source 120 status data, general power management data, etc.

Referring to FIG. 5, another example user interface 500 is shown. The user interface 500 includes an interactive area 502, where a user can input values and preferences. The interactive area 502 includes a priority list display 504, where a user can select the priority of various load sources 120. The priority list display 504 shows a device listing 512 and a corresponding priority listing 514. The user can move each load source row 506 up or down depending on its priority. Based on the hierarchy of the load source row 506, the priority of each load source 120 is determined. If the user moves the load source row 506 up, the priority goes up, and if the user moves the load source row 506 down, the priority for that particular load source 120 goes down. Higher priority load sources will be powered before lower priority load sources. As shown in the example user interface 500, powering the refrigerator will be prioritized over the other load sources 120, powering the air conditioner will be prioritized over all load sources 120 except for the refrigerator, etc. The user interface 500 also includes a “Submit Changes” selection 508 that the user can select to input the priority values and a “Cancel” selection 510 the user can select to exit the user interface 500.

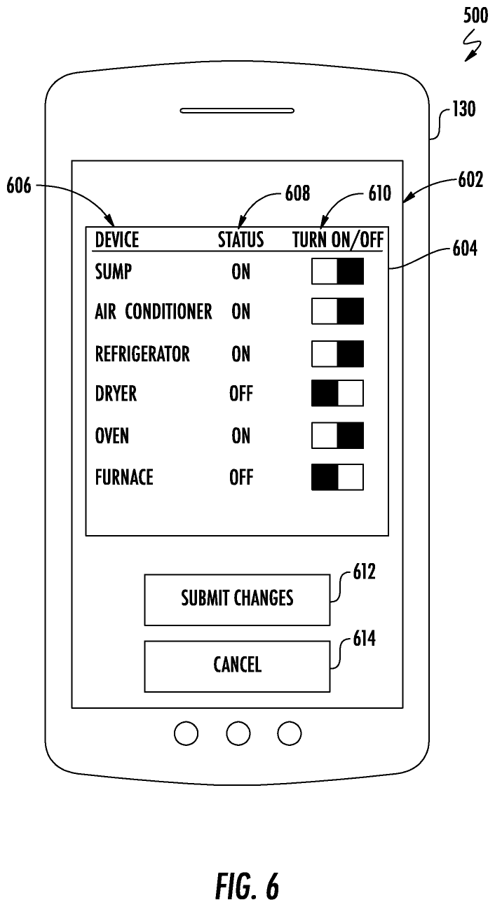

Referring to FIG. 6, another example user interface 600 is shown. The user interface 600 includes an interactive area 602, where a user can input values and preferences. The interactive area 602 includes a selection box 604 including a device listing 606, a status listing 608 for each device, and turn on/off selections 610. The user can toggle the selections 610 between on and off to indicate whether each load source should be on and receiving power from the generator 10. As shown in the example user interface 600, the user has indicated that the user does not require use of a dryer or furnace during a power outage and as such, has turned those load sources off. The user interface 600 also include a “Submit Changes” selection 612 that the user can select to input the selection values and a “Cancel” selection 614 the user can select to exit the user interface 600.

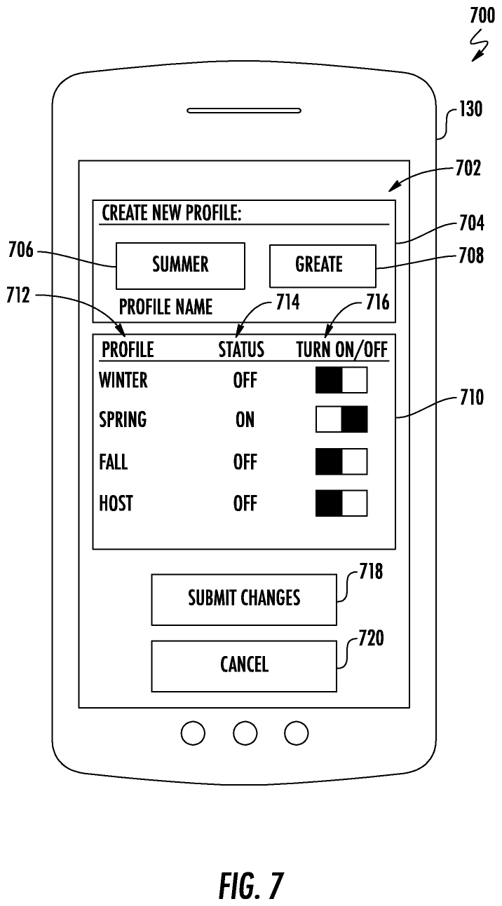

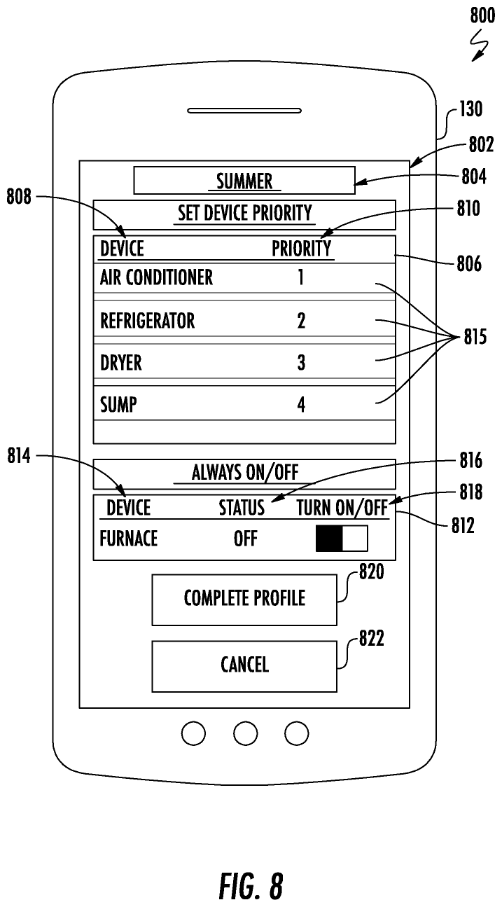

Referring to FIG. 7, another example user interface 700 is shown. The user interface 700 includes an interactive area 702, where a user can input values and preferences. The interactive area 702 includes a “Create New Profile” display 704, where a user can create a new profile setting by submitting the profile name into the “Profile Name” box 706 and selecting the “Create” selection 708. By selecting the “Create” selection 708, the user is redirected to user interface 800 shown in FIG. 8. The interactive area 702 also includes a profile selection display 710, where the user can select a profile setting. The profile selection display 710 includes a profile listing 712, a status listing 714, and turn on/off selections 716. The user can toggle the selections 716 between on and off to indicate which profile should be selected. As shown in the example user interface 700, the user has selected a “Spring” profile setting. The user interface 700 also include a “Submit Changes” selection 718 that the user can select to input the profile selection and a “Cancel” selection 720 the user can select to exit the user interface 700.

Referring to FIG. 8, another example user interface 800 is shown. The user is redirected to the user interface 800 upon selection of the “Create” selection 708 shown in FIG. 7. The user interface 800 includes an interactive area 802, where a user can input values and preferences. The interactive area 802 includes a title 804 indicating which profile is being edited, a “Set Device Priority” display 806, where the user can select the priority of various load sources 120 for the selected profile setting, and an “Always On/Off' display 812, where the user can select devices to always keep on or off with the selected profile setting. The “Set Device Priority” display 806 shows a device listing 808 and a corresponding priority listing 810. The user can move each load source row 815 up or down depending on its priority. Based on the hierarchy of the load source row 815, the priority of each load source 120 is determined. If the user moves the load source row 815 up, the priority goes up, and if the user moves the load source row 815 down, the priority for that particular load source 120 goes down. Higher priority load sources will be powered before lower priority load sources. As shown in the example user interface 800, powering the air conditioner will be prioritized over the other load sources 120, etc. The “Always On/Off” display 812 includes a device listing 814, a status 816 for that device, and a corresponding selection 818. The user can toggle the selection between on and off to indicate whether the device should always remain on or off. The user interface 800 also includes a “Complete Profile” selection 820 that the user can select to input the priority values and a “Cancel” selection 822 the user can select to exit the user interface 800.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

What is claimed is:

1. A power management system for use with a generator, the system comprising:
a generator selectively supplying power to one or more load sources, the generator including an engine;
a controller communicably and operatively coupled to the generator to control operation of the generator; and
a user device comprising a user interface and configured to receive user input on the user interface and transmit the user input to the controller;
wherein the controller comprises a priority circuit structured to receive the user input from the user device and control the generator to selectively supply power to a subset of the one or more load sources based on the user input.

2. The system of claim 1, wherein the user input includes a prioritization of the one or more load sources, the prioritization including a first priority load source and a second priority load source, wherein priority of supply of power to the first priority load source is higher than supply of power to the second priority load source;
wherein based on the user input, the priority circuit prioritizes the first priority load source over the second priority load source such that the generator is controlled to provide power to the first priority load source before providing power to the second priority load source.

3. The system of claim 1, wherein the controller is structured to generate and transmit a message for display to the user interface of the user device connected via a network indicating a status of the one of more load sources.

4. The system of claim 1, wherein the priority circuit is further configured to prioritize supplying power to a prioritized subset of the one or more load sources to maximize the remaining runtime of the generator.

5. The system of claim 1, wherein the controller and the one or more load sources are communicably coupled via a ZigBee protocol device.

6. The system of claim 1, wherein the controller is communicably coupled to the user device via Wi-Fi.

7. The system of claim 1, wherein the controller is communicably coupled to the user device via a cellular network.

8. The system of claim 1, wherein the user device comprises at least one of a mobile device, a smart home device, and a smart appliance.

9. The system of claim 1, wherein the user input includes a selection of the subset of one or more load sources to which to supply power;
wherein the priority circuit is configured to receive the user input and control the generator to selectively supply power to only the subset of one or more load sources.

10. A generator for supplying power to one or more load sources, the generator comprising:
an engine;
an alternator configured to be driven by the engine to produce electricity;
a throttle movable to a plurality of positions between closed and wide-open;
a governor coupled to the throttle to open and close the throttle; and
a controller configured to control operation of the generator and comprising a priority circuit structured to receive user input from a user device and control the generator to selectively supply power to a subset of the one or more load sources based on the user input.

11. The generator of claim 10, wherein the user input includes a prioritization of the one or more load sources, the prioritization including a first priority load source and a second priority load source, wherein priority of supply of power to the first priority load source is higher than supply of power to the second priority load source;
wherein based on the user input, the priority circuit prioritizes the first priority load source over the second priority load source such that the generator is controlled to provide power to the first priority load source before providing power to the second priority load source.

12. The generator of claim 10, further comprising:
a load sensor structured to sense a position of the throttle; and
a fuel level sensor structured to sense a fuel level in a fuel tank supplying fuel to the engine;
wherein the priority circuit is configured to evaluate a load value received from the load sensor and a fuel level value received from the fuel level sensor and prioritize supplying power to the subset of the one or more load sources based on the load value and the fuel level value.

13. The generator of claim 10, wherein the priority circuit is further structured to generate and transmit a message for display to a user device connected via a network indicating the status of the one or more load sources.

14. The generator of claim 10, wherein the priority circuit is further configured to receive user input including a selection of the subset of one or more load sources to which to supply power;
wherein the priority circuit is configured to receive the user input and control the generator to selectively supply power to only the subset of one or more load sources.

15. A power management system for use with a generator, the system comprising:
a generator selectively supplying power to one or more load sources, the generator including an engine;
a controller communicably and operatively coupled to the generator to control operation of the generator; and
a user device comprising a user interface and configured to receive user input on the user interface and transmit the user input to the controller;
wherein the controller and the one or more load sources are communicably coupled via a ZigBee protocol device.

16. The system of claim 15, wherein the controller comprises a priority circuit structured to receive the user input from the user device and control the generator to selectively supply power to a subset of the one or more load sources based on the user input.

17. The system of claim 16, wherein the user input includes a prioritization of the one or more load sources, the prioritization including a first priority load source and a second priority load source, wherein priority of supply of power to the first priority load source is higher than supply of power to the second priority load source;
wherein based on the user input, the priority circuit prioritizes the first priority load source over the second priority load source such that the generator is controlled to provide power to the first priority load source before providing power to the second priority load source.

18. The system of claim 16, wherein the generator further comprises:
a load sensor structured to sense a position of a throttle; and
a fuel level sensor structured to sense a fuel level in a fuel tank supplying fuel to the engine;
wherein the priority circuit is configured to evaluate a load value received from the load sensor and a fuel level value received from the fuel level sensor and prioritize supplying power to the subset of the one or more load sources based on the load value and the fuel level value.

19. The system of claim 15, wherein the controller is structured to generate and transmit a message for display to the user interface of the user device indicating a status of the one of more load sources.

20. The system of claim 15, wherein the user device comprises at least one of a mobile device, a smart home device, and a smart appliance.
